(19) United States
(12) Patent Application Publication
(10) Pub. No.: US 2019/0353556 A1
(43) Pub. Date: Nov. 21, 2019

(54) MAPPING LENSMETER

(71) Applicant: Reichert, Inc., Depew, NY (US)

(72) Inventors: Gabriel Norberto MARTIN, Buenos Aires (AR); Feng ZHAO, Lancaster, NY (US)

(21) Appl. No.: 16/300,997

(22) PCT Filed: May 22, 2017
(86) PCT No.: PCT/US2017/033726

§ 371 Date: Nov. 13, 2018

Related U.S. Application Data
(60) Provisional application No. 62/340,808, filed on May 24, 2016.

(51) Int. Cl. G01M 11/02

(52) U.S. Cl. CPC G01M 11/0235; G01M 11/0214; G01M 11/0278

(57) ABSTRACT

A mapping lensmeter is characterized by a macro-imaging system configured to detect a macro-image of the lens. The macro-image of the lens may be superimposed with a map of the lens indicating local refractive power at various zones of the lens to form a composite image of the lens. The composite image may include a pupil marking made on the lens.

### FIELD OF THE INVENTION

The present invention relates to the field of automatic lensmeters for measuring optical properties of eyeglass lenses and contact lenses.

### BACKGROUND OF THE INVENTION

Automatic lensmeters are used by optometrists and opticians to verify the prescription in a corrective lens by determining sphere, cylinder, axis, and prism of the lens. Automatic lensmeters are also used to orient and mark uncut lenses, and to confirm the correct mounting and prescription of lenses in spectacle frames. Automatic lensmeters are further used to check the geometric layout and accuracy of different vision zones of a progressive addition lenses (PAL).

Patients who wear PALs commonly experience discomfort. A main cause of such discomfort is misalignment between a fitting point on the PAL and the patient's pupil. The most critical type of misalignment is a shift between the fitting point and pupil along a horizontal axis. Identifying misalignment is a tedious process, explained now with reference to FIGS. 1-3. The process starts with the optician marking the pupil on the glass lens while the eyeglass frame is worn by the patient, as illustrated in FIG. 1. Then, as shown in FIG. 2, the lens is placed over a layout chart that is specific to the particular brand and model of the PAL, indicated by a Design Identifier engraving on the lens (see FIG. 3). A pair of Alignment Reference Markings on the lens are used by the optician to properly align and position the lens over the layout chart. Finally, with the lens properly aligned over the layout chart, the optician checks whether or not the pupil marking on the lens corresponds in location to a Fitting Point on the layout chart. If not, then there is misalignment.

Another frequent problem associated with PALs is that a Minimum Fitting Height of a lens is too long for the frame selected. As a result, a Near Zone of the lens may be cut off, as shown in FIG. 4. This problem can be identified by a protocol similar to that described above, and is indicated by the fact that a Near Verification Circle on the chart is partially or completely off the lens.

The approximate locations of Far and Near Reference Points of a PAL can be detected by a standard automatic lensmeter that measures one point of the PAL at a time, provided that the prescription of the PAL has no prism on the X axis. Even so, the measurement process is time consuming and the determination is not highly accurate. Mapping lensmeters that measure all points of a PAL simultaneously, for example lensmeters that utilize Shack-Hartmann wavefront analysis, already exist for accurately and quickly finding the Far and Near Reference points of a PAL. However, the known mapping lensmeters do not display an indication of where the Far and Near Reference points are in relation to the patient's pupil.

### SUMMARY OF THE INVENTION

The invention provides a mapping lensmeter comprising a lens holder configured to hold a lens, a light source unit configured to illuminate the lens with a beam of light such that a portion of the light beam is refracted by the lens, a measurement unit configured to detect the light beam after refraction by the lens and generate a corresponding signal, and a control unit configured to process the signal and generate a map of the lens indicating local refractive power at various zones of the lens. The mapping lensmeter is characterized by a macro-imaging system configured to detect a macro-image of the lens, wherein the control unit is further configured to superimpose the map of the lens and the macro-image of the lens to generate a composite image of the lens. The mapping lensmeter may further comprise a display connected to the control unit for displaying the composite image. The lens may be an eyeglass lens mounted in an eyeglass frame, and the composite image may include the eyeglass lens and at least a portion of the eyeglass frame surrounding the lens. The lens may include a pupil marking thereon, and the composite image may include the pupil marking in relation to the map of the lens.

The control unit of the mapping lensmeter may be configured to store lens fitting information for each of a plurality of lens designs, and to superimpose indicia representing the lens fitting information of a selected one of the plurality of lens designs in the composite image. The lens fitting information may include one or more of a lens fitting point, a distance verification circle, and a near verification circle.

The macro-imaging system may include a beam splitter, at least one imaging light source for illuminating the lens, an imaging lens, and a photosensitive area detector. The beam splitter may be located on the optical axis to redirect light reflected or scattered by the eyeglass lens and surrounding eyeglass frame along a macro-imaging axis to the imaging lens, which images the redirected light on the photosensitive area detector. In one embodiment, the beam splitter is located downstream from the lens holder in the direction of the measurement light beam. In another embodiment, the beam splitter is located upstream from the lens holder in the direction of the measurement light beam.

To efficiently measure a pair of eyeglass lenses, the lens holder may be movable relative to the light source unit, the measurement unit, and the macro-imaging system for positioning the second lens in alignment with the light source unit, the measurement unit, and the macro-imaging system after the first lens has been measured without removing the eyeglass frame from the lens holder unit. For even greater efficiency, the mapping lensmeter may have two light source units, two measurement units, and two macro-imaging systems connected to the control unit, whereby a pair of eyeglass lenses may be measured simultaneously by the mapping lensmeter.

The invention also encompasses a method of mapping refractive power of a lens. The method comprises generating a map of the lens indicating local refractive power at various zones of the lens, generating a macro-image of the lens, and superimposing the map and the macro-image to generate a composite image of the lens. The method may further comprise the step of indicating a pupil location on the lens with a pupil marking, wherein the composite image includes the pupil marking in relation to the map of the lens. The method may also comprise the step of superimposing indicia representing lens fitting information in the composite image, wherein the lens fitting information includes one or more of a lens fitting point, a distance verification circle, and a near verification circle.

### BRIEF DESCRIPTION OF THE DRAWING VIEWS

The nature and mode of operation of the present invention will now be more fully described in the following detailed description of the invention taken with the accompanying drawing figures, in which:

FIGS. 1 through 3 illustrate a prior art process for identifying misalignment between a fitting point on a PAL and a wearer's pupil;

FIG. 4 illustrates a problem wherein a Minimum Fitting Height of a PAL is too long for the frame selected and a Near Zone of the PAL is cut off;

FIG. 5A is a schematic diagram of an automatic mapping lensmeter formed in accordance with one embodiment of the present invention;

FIG. 5B is a schematic diagram of an automatic mapping lensmeter formed in accordance with another embodiment of the present invention;

FIG. 6 is a view showing illumination spots on a light-sensing area detector of a measurement unit of the mapping lensmeter composited with an image of a PAL being measured by the mapping lensmeter, wherein Shack Hartmann technology is used by the measurement unit;

FIG. 7 is an output image generated by the automatic mapping lensmeter wherein an image of an eyeglass frame and measured PAL is superimposed with an aberration/power map of the PAL;

FIG. 8 is a schematic top view of a mapping lensmeter according to an embodiment of the invention in which a lens holder of the mapping lensmeter shifts laterally to allow sequential measurement of first and second eyeglass lenses carried by an eyeglass frame; and

FIG. 9 is a schematic top view of a mapping lensmeter according to another embodiment of the invention, wherein the mapping lensmeter is configured to simultaneously measure first and second eyeglass lenses carried by an eyeglass frame.

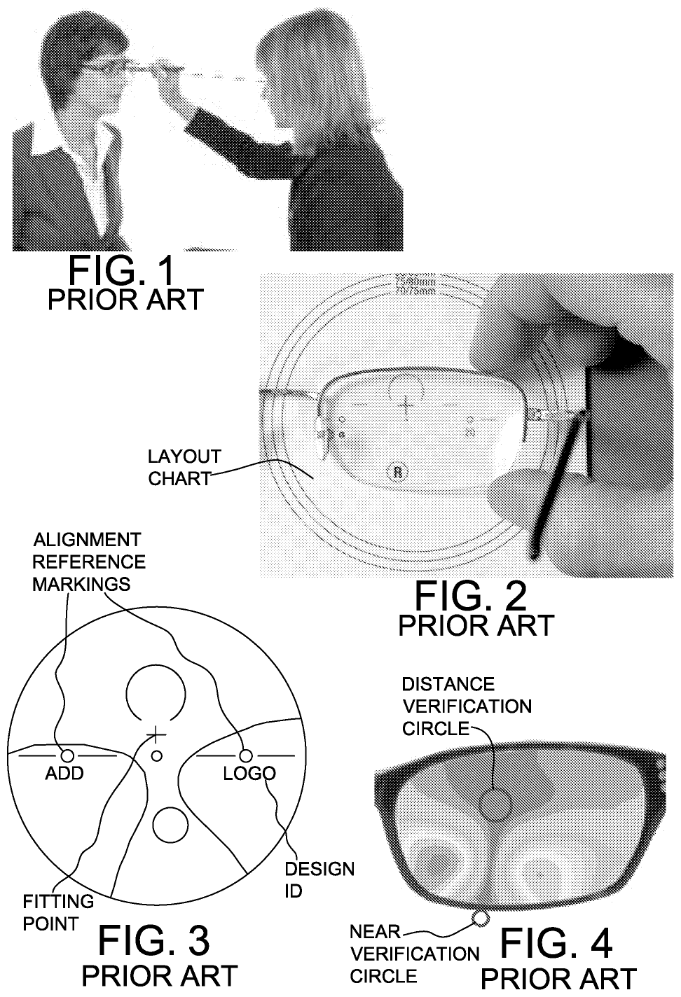

### DETAILED DESCRIPTION OF THE INVENTION

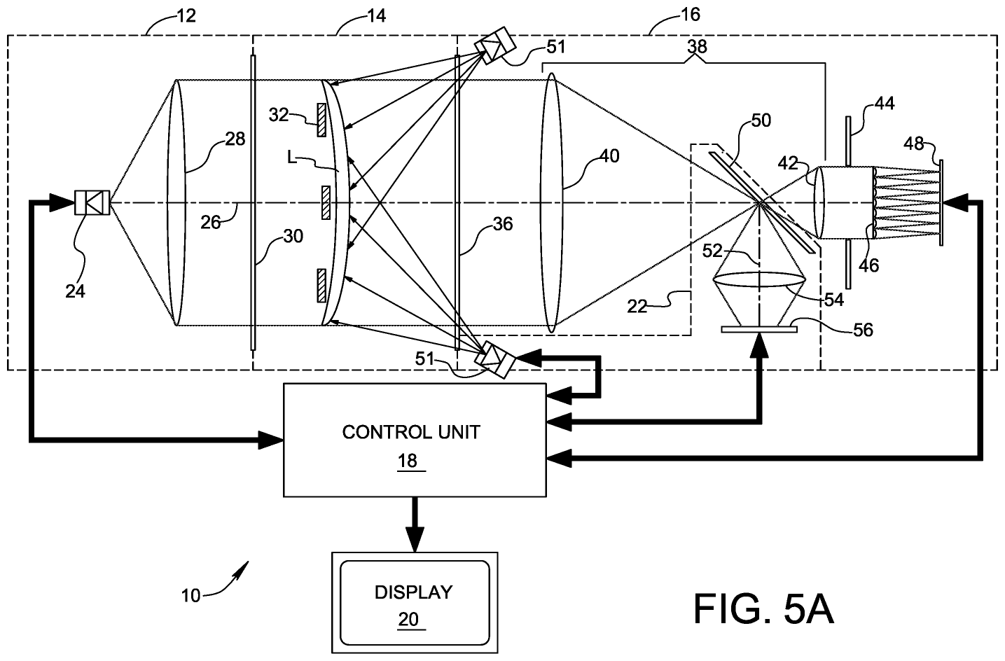

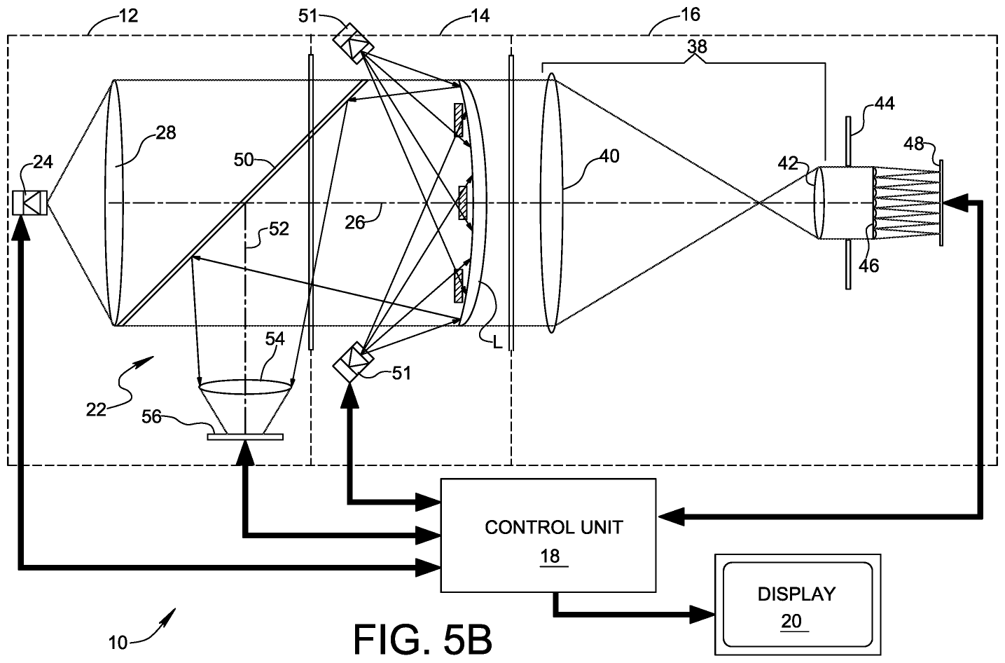

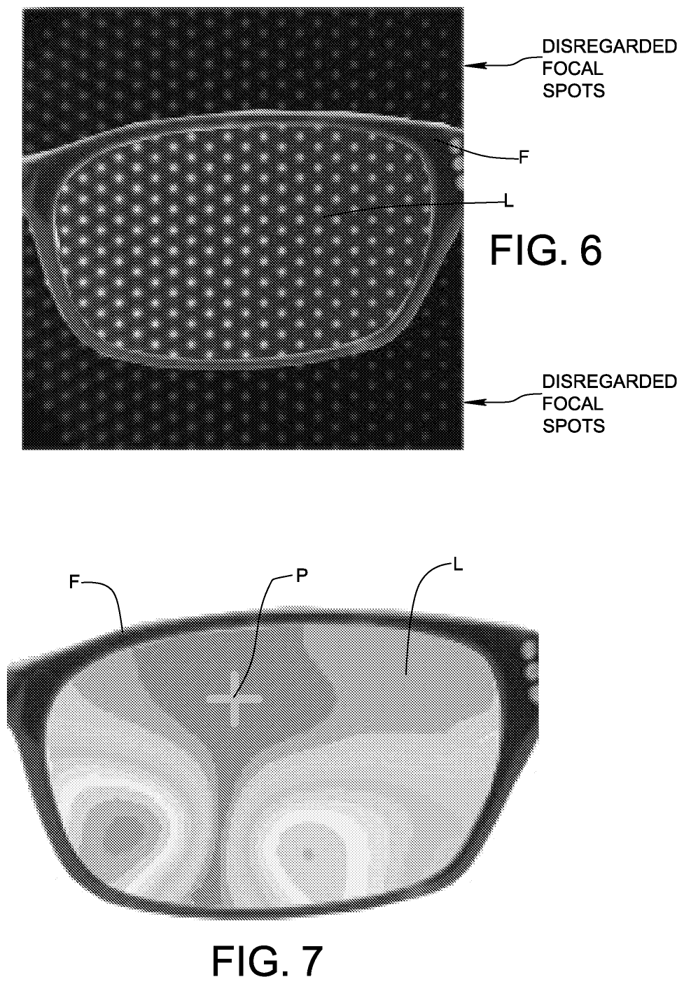

Reference is now made to FIGS. 5A through 7. FIGS. 5A and 5B schematically illustrate an automatic mapping lensmeter 10 formed in accordance with alternative embodiments of the present invention. Lensmeter 10 generally comprises a light source unit 12, a lens holding unit 14, a measurement unit 16, a control unit 18, and a display unit 20. As will be described in greater detail below, lensmeter 10 is characterized by a macro-imaging system 22 arranged to generate a macro-image of an eyeglass lens L and surrounding eyeglass frame F (see FIGS. 6 and 7) that includes a pupil marking P (see FIG. 7) on the lens L made by an optician. The macro-image may be superimposed with an aberration/power map of the lens L to provide a composite output image showing the eyeglass frame and pupil marking in relation to the aberration/power map of the lens.

Light source unit 12 has a light source 24, which may be a light-emitting diode or laser diode emitting light in a wavelength band centered at any wavelength in a range from about 400 nm to 1000 nm so that the light is detectable by a commercially available light-sensitive detector. Alternatively, light from light source 24 may be filtered by a wavelength filter (not shown) to achieve a desired wavelength band. A plurality of different selectable wavelength filters may be provided to allow adjustment of the wavelength band. As may be seen, light source 24 generates a divergent illumination beam centered and traveling along an optical axis 26. Light source unit 12 further has a collimating lens 28 arranged after light source 24 for collimating the divergent beam from light source 24. The collimated beam travels through a planar exit cover 30 of light source unit 12 toward lens holding unit 14.

Lens holding unit 14 includes a lens holder 32 for releasably stabilizing lens L and positioning the lens on optical axis 26 in the path of the illumination beam. Lens holder 32 may be configured to releasably clamp an eyeglass lens L carried by eyeglass frame F. Lens holder 32 may be similar to a lens holder or lens table used in any commercially available lensmeter, for example the ML1 manual lensmeter, and the LensChek™ Plus, LensChek™ Pro, and AL200 digital lensmeters, available from Reichert Technologies. Lens holder 32 may be adapted to hold a contact lens instead of an eyeglass lens by installing a removable contact lens holder (not shown). As may be seen, at least a portion of the illumination beam passes through and is refracted by lens L.

The refracted beam then enters measurement unit 16 through a planar cover 36 of the measurement unit. Measurement unit 16 includes telescopic lens system 38 having a first lens 40 and a second lens 42. Measurement unit 16 also includes a diaphragm 44, a two-dimensional lenslet array 46 (also known as a microlens array), and a light-sensitive area detector 48 arranged in sequence after second lens 42. As may be understood, telescopic lens system 38 scales the refracted beam before it reaches diaphragm 44. Light passing through diaphragm 44 reaches lenslet array 46, wherein individual lenslets of the lenslet array focus light onto the photosensitive elements of area detector 48. Area detector 48 may be a CCD array, CMOS chip, camera chip, or other two-dimensional array of photosensitive elements or pixels that generate signal information representative of the intensity of light received thereby. The detected image signal information is communicated to control unit 18, where it is digitized for further processing. Control unit 18 may include one or more microprocessors for carrying out image processing and performing control functions related to operation of lensmeter 10. Control unit 18 may also include one or more memory modules for storing programming instructions, calibration data, image data, and other data as needed.

Lensmeter 10 is similar to existing mapping lensmeters in that lensmeter 10 uses Shack-Hartmann wavefront sensing techniques to generate an aberration/power map of the lens L. As illustrated by FIG. 6, some light spots on area detector 48 are outside the image of lens L and may be disregarded, and only spots affected by lens L are used to generate the aberration/power map. FIG. 7 depicts a typical aberration/power map in gray scale shading (color is normally used to indicate local power at a region of the lens). The near and far zones of lens L are distinguishable in the map.

Lensmeter 10 is characterized by macro-imaging system 22. Macro-imaging system 22 may include a beam splitter 50 arranged on optical axis 26 to redirect light reflected or scattered by the eyeglass lens L and surrounding eyeglass frame F along a macro-imaging axis 52. In the embodiment illustrated in FIG. 5A, beam splitter 50 is located downstream from lens holder 32 in a direction of the measurement light beam originating from measurement light source 24. In the embodiment illustrated in FIG. 5B, beam splitter 50 is located upstream from lens holder 32 in a direction of the measurement light beam.

Light for macro-imaging purposes may be supplied by one or more imaging light sources 51 obliquely directed toward eyeglass lens L and an associated eyeglass frame. As shown in FIG. 5A, beam splitter 50 may also redirect a portion of the measurement light beam originating from light source 24 for travel along macro-imaging axis 52, and transmit the remaining portion of the measurement light beam. Light from imaging light sources 51 and light from measurement light source 24 may be emitted having, or filtered to have, two different wavelength bands or the same wavelength band. If different wavelength bands are provided, then beam splitter 50 may be selected to reflect the wavelength band associated with imaging light sources 51 and to transmit the wavelength band associated with measurement light source 24.

Macro-imaging system 22 also includes an imaging lens 54 and a photosensitive area detector 56, whereby light reflected along macro-imaging axis 52 by beam splitter 50 is imaged by imaging lens 54 onto area detector 56 to capture a macro-image of lens L and at least a portion of frame F. Area detector 56 may be a CCD array, CMOS chip, camera chip, or other two-dimensional array of photosensitive elements or pixels that generate signal information representative of the intensity of light received thereby.

As mentioned above, the macro-image of lens L and surrounding eyeglass frame F, including the pupil marking P on lens L made by the optician, may be superimposed with an aberration/power map of the lens L. The image superimposition provides a composite output image as shown in FIG. 7 showing the pupil marking P on lens L in relation to the aberration/power map of the lens. The aberration/power map should have some degree of transparency so that the pupil marking P is visible in the composite output image. Superimposition of the image information may be carried out in control unit 18 using a suitable image processing and superimposition routine. The composite output image may be displayed on display 20 and/or printed by a printing device (not shown).

In a further aspect of the invention, a database containing information about lens designs offered by various lens manufacturers—including lens fitting point, distance verification circle, and near verification circle information—may be stored in memory of lensmeter 10. Control unit 18 may be configured to allow an operator to retrieve lens design information corresponding to a measured lens L, and to superimpose indicia showing the location of the intended fitting point, distance verification circle, and near verification circle in the composite output image. In this way, the relationship between the hand-marked pupil point P, the intended fitting point, other lens design specifications, and the mapped power zones of a PAL may be easily seen by the operator in one image.

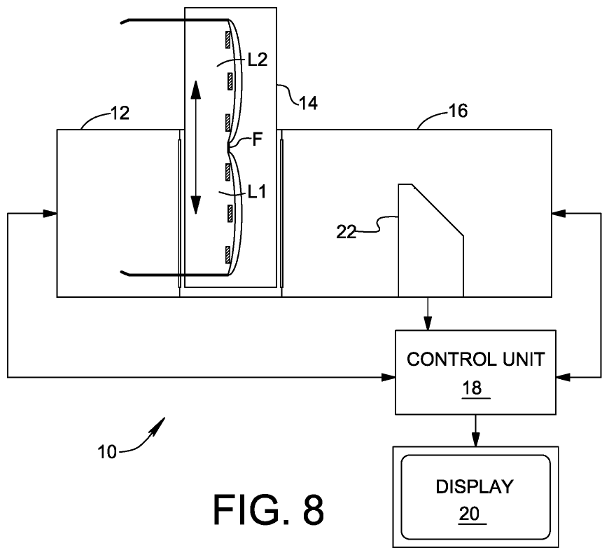

Mapping lensmeter 10 may have a fixed lens holder 32 that requires the user to remove a first lens from the lens holder 32 after the first lens is measured and insert a second lens into the lens holder to measure the second lens. However, as shown in the embodiment of FIG. 8, lens holder 32 of lens holding unit 14 may hold a pair of eyeglasses and move relative to light source unit 12 and measurement unit 16, whereby the second eyeglass lens L2 carried by eyeglass frame F is measured sequentially after the first eyeglass lens by moving the lens holder relative to the light source unit and the measurement unit. This avoids the need to remove the eyeglasses from holder 32 and reposition the eyeglasses in the holder between measurements, thereby speeding up the measurement process. The movement of lens holder 32 may be achieved by moving the entire lens holder unit 14 relative to light source unit 12 ad measurement unit 16, or by moving lens holder 32 within lens holder unit 14. The movement may be manually powered or automatically powered by a motor drive (not shown).

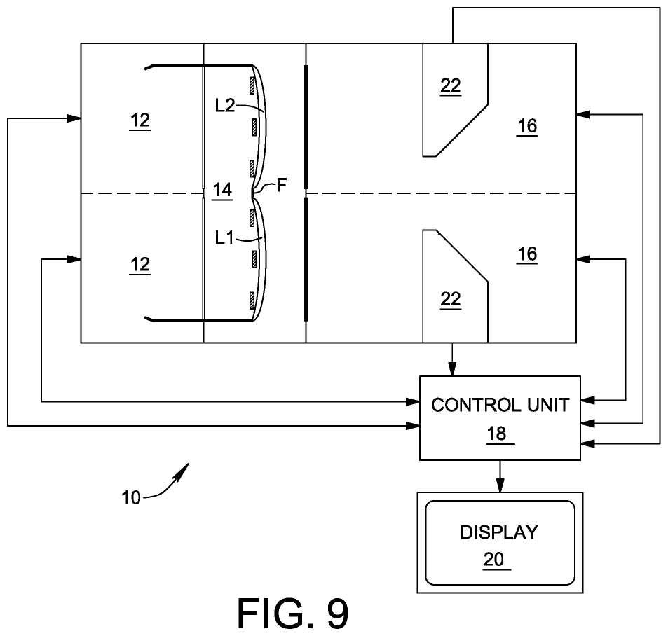

In another embodiment, shown in FIG. 9, mapping lensmeter 10 has two light source units 12, two measurement units 16, and two macro-imaging systems 22 connected to control unit 18, whereby first eyeglass lens L1 and second eyeglass lens L2 are measured simultaneously by mapping lensmeter 10. The single lens holding unit 14 may remain in a fixed position.

The present invention is also embodied by a method of mapping refractive power of a lens. The method comprises the steps of generating a map of the lens indicating local refractive power at various zones of the lens, generating a macro-image of the lens, and superimposing the map and the macro-image to generate a composite image of the lens. The method may further comprise the step of indicating a pupil location on the lens with a pupil marking, wherein the composite image includes the pupil marking in relation to the map of the lens. The pupil marking may be made with a marking pen. The method may further comprise the step of superimposing indicia representing lens fitting information in the composite image. The lens fitting information may include one or more of a lens fitting point, a distance verification circle, and a near verification circle. The lens fitting information may be stored in memory which may be provided as part of control unit 18.

As will be appreciated from the foregoing description, mapping lensmeter 10 of the present invention improves efficiency in fitting prescription lenses and eyeglass frames, and in resolving problems that may be experienced by a patient stemming from improper fit.

What is claimed is:

1. A mapping lensmeter comprising:
a lens holder configured to position a lens on an optical axis;
a light source unit including at least one measurement light source, the light source unit being configured to illuminate the lens with a light beam, wherein a portion of the light beam is refracted by the lens;
a measurement unit configured to detect the light beam after refraction by the lens and generate a corresponding signal;
a control unit configured to process the signal and generate a map of the lens indicating local refractive power at various zones of the lens; and
a macro-imaging system configured to detect a macro-image of the lens;
wherein the control unit is further configured to superimpose the map of the lens and the macro-image of the lens to generate a composite image of the lens.

2. The mapping lensmeter according to claim 1, further comprising a display connected to the control unit for displaying the composite image.

3. The mapping lensmeter according to claim 1, wherein the lens includes a pupil marking thereon, and the composite image includes the pupil marking in relation to the map of the lens.

4. The mapping lensmeter according to claim 1, wherein the control unit is configured to store lens fitting information for each of a plurality of lens designs, and to superimpose indicia representing the lens fitting information of a selected one of the plurality of lens designs in the composite image.

5. The mapping lensmeter according to claim 1, wherein the lens fitting information includes one or more of a lens fitting point, a distance verification circle, and a near verification circle.

6. The mapping lensmeter according to claim 1, wherein a wavelength band of the light beam is adjustable.

7. The mapping lensmeter according to claim 1, wherein the macro-imaging system includes a beam splitter on the optical axis for redirecting light along a macro-imaging axis differing from the optical axis.

8. The mapping lensmeter according to claim 7, wherein the beam splitter is located on the optical axis downstream from the lens holder in a direction of the light beam.

9. The mapping lensmeter according to claim 7, wherein the beam splitter is located on the optical axis upstream from the lens holder in a direction of the light beam.

10. The mapping lensmeter according to claim 7, wherein the macro-imaging system further includes at least one imaging light source for illuminating the lens to assist detection of the macro-image of the lens.

11. The mapping lensmeter according to claim 10, wherein light from the at least one imaging light source is emitted having or is filtered to have a first wavelength band, and light from the at least one measurement light source is emitted having or is filtered to have a second wavelength band different from the first wavelength band.

12. The mapping lensmeter according to claim 10, wherein light from the at least one imaging light source is emitted having or is filtered to have a first wavelength band, and light from the at least one measurement light source is emitted having or is filtered to have the first wavelength band.

13. The mapping lensmeter according to claim 7, wherein the macro-imaging system further includes an imaging lens and a photosensitive area detector receiving the redirected light.

14. The mapping lensmeter according to claim 1, wherein the lens is a first eyeglass lens carried in an eyeglass frame, the lens holder is configured to hold the eyeglass frame, and the macro-image of the first eyeglass lens includes at least a portion of the eyeglass frame.

15. The mapping lensmeter according to claim 14, wherein the lens holder is movable relative to the measurement unit, whereby a second eyeglass lens carried by the eyeglass frame is measured sequentially after the first eyeglass lens by moving the lens holder relative to the measurement unit.

16. The mapping lensmeter according to claim 14, wherein the eyeglass frame carries a second eyeglass lens, and the mapping lensmeter further comprises:
a second light source unit configured to illuminate the second eyeglass lens with a second beam of collimated light, wherein a portion of the second light beam is refracted by the second eyeglass lens;
a second measurement unit configured to detect the second light beam after refraction by the second eyeglass lens and generate a corresponding second image signal; and
a second macro-imaging system configured to detect a macro-image of the second eyeglass lens;
wherein the control unit is further configured to process the second image signal and generate a map of the second eyeglass lens indicating local refractive power at various zones of the second eyeglass lens, and to superimpose the map of the second eyeglass lens and the macro-image of the second eyeglass lens to generate a composite image of the second eyeglass lens;
whereby the first eyeglass lens and the second eyeglass lens are measured simultaneously by the mapping lensmeter.

17. A method of mapping refractive power of a lens, the method comprising the steps of:
generating a map of the lens indicating local refractive power at various zones of the lens;
generating a macro-image of the lens; and
superimposing the map and the macro-image to generate a composite image of the lens,

18. The method of claim 17, further comprising the step of indicating a pupil location on the lens with a pupil marking, wherein the composite image includes the pupil marking in relation to the map of the lens.

19. The method of claim 17, further comprising the step of superimposing indicia representing lens fitting information in the composite image, wherein the lens fitting information includes one or more of a lens fitting point, a distance verification circle, and a near verification circle.
